(19) United States
(12) Patent Application Publication
(10) Pub. No.: US 2024/0425682 A1
(43) Pub. Date: Dec. 26, 2024

(54) ARTICLES COMPRISING MELT PROCESSABLE CELLULOSE ACETATE COMPOSITIONS COMPRISING AMORPHOUS BIOFILLER

(71) Applicant: Eastman Chemical Company, Kingsport, TN (US)

(72) Inventors: Gaurav Amarpuri, Alpharetta, GA (US); Stephanie Kay Clendennen, Kingsport, TN (US)

(73) Assignee: Eastman Chemical Company, Kingsport, TN (US)

(21) Appl. No.: 18/698,407

(22) PCT Filed: Oct. 7, 2022
(86) PCT No.: PCT/US2022/045993

§ 371 Date: Apr. 4, 2024

Related U.S. Application Data
(60) Provisional application No. 63/262,253, filed on Oct. 8, 2021.

(51) Int. Cl. C08L 1/12; C08K 5/00

(52) U.S. Cl. CPC C08L 1/12; C08K 5/0016; C08L 2201/06; C08L 2201/08

(57) ABSTRACT

The present application discloses cellulose ester compositions comprising starches having a degree of branching of from 2 to 6. The cellulose ester compositions exhibit improved industrial compostability and higher heat deflection temperatures over cellulose ester compositions having lower degrees of branching.

### BACKGROUND OF THE INVENTION

There is a well-known global issue with waste disposal, particularly of large volume consumer products such as plastics or polymers that are not considered biodegradable within acceptable temporal limits. There is a public desire to incorporate these types of wastes into renewed products through recycling, reuse, or otherwise reducing the amount of waste in circulation or in landfills. This is especially true for single-use plastic articles/materials.

As consumer sentiment regarding the environmental fate of single-use plastics, such as straws, to-go cups, and plastic bags, are becoming a global trend, plastics bans are being considered/enacted around the world in both developed and developing nations. Bans have extended from plastic shopping bags into straws, cutlery, and clamshell packaging, for example, in the US alone. Other countries have taken even more extreme steps, such as the list of ten single-use articles slated to be banned, restricted in use, or mandated to have extended producer responsibilities throughout the EU. As a result, industry leaders, brand owners, and retailers have made ambitious commitments to implement recyclable, reusable or compostable packaging in the coming years. While recyclable materials are desirable in some applications, other applications lend themselves better to materials that are compostable and/or biodegradable, such as when the article is contaminated with food or when there are high levels of leakage into the environment due to inadequate waste management systems.

Single-use plastic articles are frequently used in food service, intended to be used once for storing or serving food, after which the articles are discarded. To prevent the persistence of these articles it is desirable for the articles to disintegrate and biodegrade, even thicker parts like cup rims and utensils. Disintegration in compost is an end-of life fate that would re-direct these single-use plastic articles from landfill. Single-use plastic articles can range in thickness from less than 5 mil (e.g. straws) to greater than 100 mil (e.g. utensils). For some materials, the rate of disintegration in compost is proportional to the article thickness, i.e. thicker articles take longer to disintegrate, or may not disintegrate within that standard time frame of the composting cycle.

It is desirable to have articles made from biobased materials that have been formulated to disintegrate in compost, even when the articles are 30 mil thick or greater. Furthermore, the appearance of the articles should be suitable for the application (not dark in color and not opaque).

Therefore, there is a market need for single-use consumer products that have adequate performance properties for their intended use and that are compostable and/or biodegradable.

It would be beneficial to provide products having such properties and that also have significant content of renewable, recycled, and/or re-used material.

Applicants have found that cellulose ester compositions comprising highly branched starches exhibit improved industrial compostability over cellulose ester compositions having starches with lower degrees of branching.

### SUMMARY OF THE INVENTION

The present application discloses a cellulose ester composition comprising at least one biodegradable cellulose ester, at least one plasticizer, and at least one branched, amorphous biofiller; wherein said biofiller has a degree of branching of 2 to 6; wherein said cellulose ester composition has a disintegrable rate of 50% or more.

In another embodiment of the invention, a process is provided to produce a cellulose ester composition. The process comprises contacting at least one biodegradable cellulose ester, at least one plasticizer, and at least one branched, amorphous biofiller; wherein said biofiller has a degree of branching of 2 to 6; wherein said cellulose ester composition has a disintegrable rate of 50% or more.

In another embodiment of the invention, an article is provided comprising a melt processable cellulose ester composition; wherein said cellulose ester composition comprises at least one biodegradable cellulose ester, at least one plasticizer, and at least one branched, amorphous biofiller; wherein said biofiller has a degree of branching of 2 to 6; wherein said cellulose ester composition has a disintegrable rate of 50% or more.

### DETAILED DESCRIPTION OF THE INVENTION

In this invention, a melt processable cellulose ester composition is provided comprising at least one biodegradable cellulose ester, at least one plasticizer, and at least one branched, amorphous biofiller; wherein said biofiller has a degree of branching of 2 to 6; wherein said cellulose ester composition has a disintegrable rate of 50% or more. The test method to determine the disintegrable rate is provided subsequently in this disclosure.

### Cellulose Ester

The cellulose ester utilized in this invention can be any that is known in the art. Cellulose ester that can be used for the present invention generally comprise repeating units of the structure:

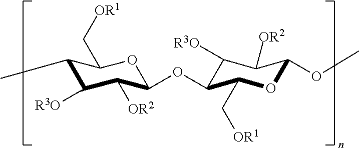

wherein R¹, R², and R³ are selected independently from the group consisting of hydrogen acetyl, propyl or butyl. The substitution level of the cellulose ester is usually expressed in terms of degree of substitution (DS), which is the average number of non-OH substituents per anhydroglucose unit (AGU). Generally, conventional cellulose contains three hydroxyl groups in each AGU unit that can be substituted; therefore, DS can have a value between zero and three. Native cellulose is a large polysaccharide with a degree of polymerization from 250-5,000 even after pulping and purification, and thus the assumption that the maximum DS is 3.0 is approximately correct. Because DS is a statistical mean value, a value of 1 does not assure that every AGU has a single substitutent. In some cases, there can be unsubstituted anhydroglucose units, some with two and some with three substitutents, and typically the value will be a non-integer. Total DS is defined as the average number of all of substituents per anhydroglucose unit. The degree of substitution per AGU can also refer to a particular substitutent, such as, for example, hydroxyl or acetyl. In embodiments, n is an integer in a range from 25 to 250, or 25 to 200, or 25 to 150, or 25 to 100, or 25 to 75.

In embodiments of the invention, the cellulose esters have at least 2 anhydroglucose rings and can have between at least 50 and up to 5,000 anhydroglucose rings, or at least 50 and less than 150 anhydroglucose rings. The number of anhydroglucose units per molecule is defined as the degree of polymerization (DP) of the cellulose ester. In embodiments, cellulose esters can have an inherent viscosity (IV) of about 0.2 to about 3.0 deciliters/gram, or about 0.5 to about 1.8, or about 1 to about 1.5, as measured at a temperature of 25° C. for a 0.25 gram sample in 100 ml of a 60/40 by weight solution of phenol/tetrachloroethane. In embodiments, cellulose esters useful herein can have a DS/AGU of about 1 to about 2.5, or 1 to less than 2.2, or 1 to less than 1.5, and the substituting ester is acetyl.

Cellulose esters can be produced by any method known in the art. Examples of processes for producing cellulose esters are taught in Kirk-Othmer, Encyclopedia of Chemical Technology, 5th Edition, Vol. 5, Wiley-Interscience, New York (2004), pp. 394-444. Cellulose, the starting material for producing cellulose esters, can be obtained in different grades and sources such as from cotton linters, softwood pulp, hardwood pulp, corn fiber and other agricultural sources, and bacterial cellulose, among others.

One method of producing cellulose esters is esterification of the cellulose by mixing cellulose with the appropriate organic acids, acid anhydrides, and catalysts. Cellulose is then converted to a cellulose triester. Ester hydrolysis is then performed by adding a water-acid mixture to the cellulose triester, which can then be filtered to remove any gel particles or fibers. Water is then added to the mixture to precipitate the cellulose ester. The cellulose ester can then be washed with water to remove reaction by-products followed by dewatering and drying.

The cellulose triesters to be hydrolyzed can have three acetyl substituents. These cellulose esters can be prepared by a number of methods known to those skilled in the art. For example, cellulose esters can be prepared by heterogeneous acylation of cellulose in a mixture of carboxylic acid and anhydride in the presence of a catalyst such as H₂SO₄. Cellulose triesters can also be prepared by the homogeneous acylation of cellulose dissolved in an appropriate solvent such as LiCl/DMAc or LiCl/NMP.

Those skilled in the art will understand that the commercial term of cellulose triesters also encompasses cellulose esters that are not completely substituted with acyl groups. For example, cellulose triacetate commercially available from Eastman Chemical Company, Kingsport, TN, U.S.A., typically has a DS from about 2.85 to about 2.99.

After esterification of the cellulose to the triester, part of the acyl substituents can be removed by hydrolysis or by alcoholysis to give a secondary cellulose ester. As noted previously, depending on the particular method employed, the distribution of the acyl substituents can be random or non-random. Secondary cellulose esters can also be prepared directly with no hydrolysis by using a limiting amount of acylating reagent. This process is particularly useful when the reaction is conducted in a solvent that will dissolve cellulose. All of these methods yield cellulose esters that are useful in this invention.

In one embodiment or in combination with any of the mentioned embodiments, or in combination with any of the mentioned embodiments, the cellulose acetates are cellulose diacetates that have a polystyrene equivalent number average molecular weight (Mn) from about 10,000 to about 100,000 as measured by gel permeation chromatography (GPC) using NMP as solvent and polystyrene equivalent Mn according to ASTM D6474. In embodiments, the cellulose acetate composition comprises cellulose diacetate having a polystyrene equivalent number average molecular weights (Mn) from 10,000 to 90,000; or 10,000 to 80,000; or 10,000 to 70,000; or 10,000 to 60,000; or 10,000 to less than 60,000; or 10,000 to less than 55,000; or 10,000 to 50,000; or 10,000 to less than 50,000; or 10,000 to less than 45,000; or 10,000 to 40,000; or 10,000 to 30,000; or 20,000 to less than 60,000; or 20,000 to less than 55,000; or 20,000 to 50,000; or 20,000 to less than 50,000; or 20,000 to less than 45,000; or 20,000 to 40,000; or 20,000 to 35,000; or 20,000 to 30,000; or 30,000 to less than 60,000; or 30,000 to less than 55,000; or 30,000 to 50,000; or 30,000 to less than 50,000; or 30,000 to less than 45,000; or 30,000 to 40,000; or 30,000 to 35,000; as measured by gel permeation chromatography (GPC) using NMP as solvent and according to ASTM D6474.

The most common commercial secondary cellulose esters are prepared by initial acid catalyzed heterogeneous acylation of cellulose to form the cellulose triester. After a homogeneous solution in the corresponding carboxylic acid of the cellulose triester is obtained, the cellulose triester is then subjected to hydrolysis until the desired degree of substitution is obtained. After isolation, a random secondary cellulose ester is obtained. That is, the relative degree of substitution (RDS) at each hydroxyl is roughly equal.

The cellulose esters useful in the present invention can be prepared using techniques known in the art, and can be chosen from various types of cellulose esters, such as for example the cellulose esters that can be obtained from Eastman Chemical Company, Kingsport, TN, U.S.A., e.g., Eastman™ Cellulose Acetate CA 398-30 and Eastman™ Cellulose Acetate CA 398-10, Eastman™ CAP 485-20 cellulose acetate propionate; Eastman™ CAB 381-2 cellulose acetate butyrate.

In embodiments of the invention, the cellulose ester can be prepared by converting cellulose to a cellulose ester with reactants that are obtained from recycled materials, e.g., a recycled plastic content syngas source. In embodiments, such reactants can be cellulose reactants that include organic acids and/or acid anhydrides used in the esterification or acylation reactions of the cellulose, e.g., as discussed herein.

In one embodiment or in combination with any of the mentioned embodiments, or in combination with any of the mentioned embodiments, of the invention, a cellulose ester composition comprising at least one recycle cellulose ester is provided, wherein the cellulose ester has at least one substituent on an anhydroglucose unit (AU) derived from recycled content material, e.g., recycled plastic content syngas.

Plasticizer In embodiments, the melt processable and biodegradable cellulose ester composition can comprise at least one plasticizer. The plasticizer reduces the melt temperature, the Tg, and/or the melt viscosity of the cellulose ester. Plasticizers for cellulose esters may include glycerol triacetate (Triacetin), glycerol diacetate, dibutyl terephthalate, dimethyl phthalate, diethyl phthalate, poly(ethylene glycol) MW 200-600, triethylene glycol dipropionate, 1,2-epoxypropylphenyl ethylene glycol, 1,2-epoxypropyl(m-cresyl) ethylene glycol, 1,2-epoxypropyl(o-cresyl) ethylene glycol, β-oxyethyl cyclohexenecarboxylate, bis(cyclohexanate) diethylene glycol, triethyl citrate, polyethylene glycol, Benzoflex, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate, triethyl citrate, acetyl triethyl citrate, polyethylene glycol, the benzoate containing plasticizers such as the Benzoflex™ plasticizer series, poly (alkyl succinates) such as poly (butyl succinate), polyethersulfones, adipate based plasticizers, soybean oil epoxides such as the Paraplex™ plasticizer series, sucrose based plasticizers, dibutyl sebacate, tributyrin, tripropionin, sucrose acetate isobutyrate, the Resolflex™ series of plasticizers, triphenyl phosphate, glycolates, methoxy polyethylene glycol, 2,2,4-trimethylpentane-1,3-diyl bis(2-methylpropanoate), and polycaprolactones.

In embodiments, the plasticizer is a food-compliant plasticizer. By food-compliant is meant compliant with applicable food additive and/or food contact regulations where the plasticizer is cleared for use or recognized as safe by at least one (national or regional) food safety regulatory agency (or organization), for example listed in the 21 CFR Food Additive Regulations or otherwise Generally Recognized as Safe (GRAS) by the US FDA. In embodiments, the food-compliant plasticizer is triacetin or polyethylene glycol (PEG) having a molecular weight of about 200 to about 600. In embodiments, examples of food-compliant plasticizers that could be considered can include triacetin, triethyl citrate, polyethylene glycol, Benzoflex, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate.

In embodiments, the plasticizer can be present in an amount sufficient to permit the cellulose ester composition to be melt processed (or thermally formed) into useful articles, e.g., single use plastic articles, in conventional melt processing equipment. In embodiments, the plasticizer is present in an amount from 1 to 40 wt % for most thermoplastics processing; or 5 to 25 wt %, or 10 to 25 wt %, or 12 to 20 wt % based on the weight of the cellulose ester composition. In embodiments, profile extrusion, sheet extrusion, thermoforming, and injection molding can be accomplished with plasticizer levels in the 10-30, or 12-25, or 15-20, or 10-25 wt % range, based on the weight of the cellulose ester composition.

In embodiments, the plasticizer is a biodegradable plasticizer. Some examples of biodegradable plasticizers include triacetin, triethyl citrate, acetyl triethyl citrate, polyethylene glycol, the benzoate containing plasticizers such as the Benzoflex™ plasticizer series, poly (alkyl succinates) such as poly (butyl succinate), polyethersulfones, adipate based plasticizers, soybean oil epoxides such as the Paraplex™ plasticizer series, sucrose based plasticizers, dibutyl sebacate, tributyrin, the Resoflex™ series of plasticizers, triphenyl phosphate, glycolates, polyethylene glycol, 2,2,4-trimethylpentane-1,3-diyl bis(2-methylpropanoate), and polycaprolactones.

### PEG/MPEG Specific Compositions

In one embodiment of the invention, the cellulose ester composition can contain a plasticizer selected from the group consisting of PEG and MPEG (methoxy PEG). The polyethylene glycol or a methoxy polyethylene glycol composition having an average molecular weight of from 200 Daltons to 600 Daltons, wherein the composition is melt processable, biodegradable, and disintegrable.

In one embodiment or in combination with any other embodiment, the composition comprises polyethylene glycol or methoxy PEG having an average molecular weight of from 300 to 550 Daltons.

In one embodiment or in combination with any other embodiment, the composition comprises polyethylene glycol having an average molecular weight of from 300 to 500 Daltons.

In embodiments, the cellulose ester composition comprises at least one plasticizer (as described herein) in an amount from 1 to 40 wt %, or 5 to 40 wt %, or 10 to 40 wt %, or 12 to 40 wt %, 13 to 40 wt %, or 15 to 40 wt %, or greater than 15 to 40 wt %, or 17 to 40 wt %, or 20 to 40 wt %, or 25 to 40 wt %, or 5 to 35 wt %, or 10 to 35 wt %, or 13 to 35 wt %, or 15 to 35 wt %, or greater than 15 to 35 wt %, or 17 to 35 wt %, or 20 to 35 wt %, or 5 to 30 wt %, or 10 to 30 wt %, or 13 to 30 wt %, or 15 to 30 wt %, or greater than 15 to 30 wt %, or 17 to 30 wt %, or 5 to 25 wt %, or 10 to 25 wt %, or 13 to 25 wt %, or 15 to 25 wt %, or greater than 15 to 25 wt %, or 17 to 25 wt %, or 5 to 20 wt %, or 10 to 20 wt %, or 13 to 20 wt %, or 15 to 20 wt %, or greater than 15 to 20 wt %, or 17 to 20 wt %, or 5 to 17 wt %, or 10 to 17 wt %, or 13 to 17 wt %, or 15 to 17 wt %, or greater than 15 to 17 wt %, or 5 to less than 17 wt %, or 10 to less than 17 wt %, or 13 to less than 17 wt %, or 15 to less than 17 wt %, all based on the total weight of the cellulose ester composition.

In embodiments, the at least one plasticizer includes or is a food-compliant plasticizer. In an embodiment, the food-compliant plasticizer includes or is triacetin or PEG MW 300 to 500.

In embodiments, the cellulose ester composition comprises a biodegradable cellulose ester (BCE) component that comprises at least one BCE and a biodegradable polymer component that comprises at least one other biodegradable polymer (other than the BCE). In embodiments, the other biodegradable polymer can be chosen from polyhydroxyalkanoates (PHAs and PHBs), polylactic acid (PLA), polycaprolactone polymers (PCL), polybutylene adipate terephthalate (PBAT), polyethylene succinate (PES), polyvinyl acetates (PVAs), polybutylene succinate (PBS) and copolymers (such as polybutylene succinate-co-adipate (PBSA)), cellulose esters, cellulose ethers, starch, proteins, derivatives thereof, and combinations thereof. In embodiments, the cellulose ester composition comprises two or more biodegradable polymers. In embodiments, the cellulose ester composition contains a biodegradable polymer (other than the BCE) in an amount from 0.1 to less than 50 wt %, or 1 to 40 wt %, or 1 to 30 wt %, or 1 to 25 wt %, or 1 to 20 wt %, based on the cellulose ester composition. In embodiments, the cellulose ester composition contains a biodegradable polymer (other than the BCE) in an amount from 0.1 to less than 50 wt %, or 1 to 40 wt %, or 1 to 30 wt %, or 1 to 25 wt %, or 1 to 20 wt %, based on the total amount of BCE and biodegradable polymer. In embodiments, the at least one biodegradable polymer comprises a PHA having a weight average molecular weight (Mw) in a range from 10,000 to 1,000,000, or 50,000 to 1,000,000, or 100,000 to 1,000,000, or 250,000 to 1,000,000, or 500,000 to 1,000,000, or 600,000 to 1,000,000, or 600,000 to 900,000, or 700,000 to 800,000, or 10,000 to 500,000, or 10,000 to 250,000, or 10,000 to 100,000, or 10,000 to 50,000, measured using gel permeation chromatography (GPC) with a refractive index detector and polystyrene standards employing a solvent of methylene chloride. In embodiments, the PHA can include a polyhydroxybutyrate-co-hydroxyhexanoate.

### Branched, Amorphous Biofiller

The branched, amorphous biofiller utilized in the cellulose ester composition can be any that is known in the art having a degree of branching of from 2 to 6 as determined by the method specified in the Examples of this application. Degree of branching (DB) of starches depends primarily on the plant source. In some embodiments, the biofiller of the invention may have a degree of branching of 3 or greater, 4 or greater, and 5 or greater as determined by NMR. Some examples of plant starches with a DB of 3 or greater are tulip starch, waxy corn starch, waxy potato starch and native corn starch. Other examples of plant starches have a DB of less than 3, or may be too low to measure by NMR.

| Branched, Amorphous | DB by |
|---|---|
| Biofiller | NMR |
| Tulip starch | 5.5 |
| Waxy corn starch | 4.9 |
| Waxy potato starch | 3.8 |
| Native corn starch | 3.1 |
| Potato starch | 2.8 |
| High amylose corn starch | Too low |
| Green pea starch | Too low |

Source: Gaenssle et al., 2021, Long chains and crystallinity govern the enzymatic degradability of gelatinized starches from conventional and new sources. Carbohydrate Polymers 260, 11780; herein incorporated by reference to the extent it does not contradict this application.

The amount of biofiller is that which is sufficient to obtain a disintegrable rate of 50% or more. In embodiments of the invention, the amount of biofiller can range from about 1 to about 50% by weight based on the cellulose ester composition. Other ranges include from about 5 to about 50%, from about 10 to about 50%, from about 15 to about 50%, from about 20 to about 50%, from about 25 to about 50%, from about 30 to about 50%, from about 35 to about 50%, from about 40 to about 50%, and from about 45 to about 50% by weight based on the weight of the cellulose ester compositions.

Although not wishing to be bound by theory, the branched, amorphous biofiller can reduce the crystallinity of the biofiller, thereby enabling absorption of moisture and microbes during degradation. The access to microbial activity and high degradation rate in the cellulose ester, particularly, cellulose acetates, enables the disintegration rate enhancement in cellulose ester containing thermoplastics. The addition of biofiller to the plasticized cellulose ester with a increases the disintegration rate of formulated CDA articles significantly.

In embodiments of the invention, the biofiller is compatible with the cellulose ester and disperse well in the cellulose ester matrix and do not have an significant impact on the physical properties of the cellulose ester. In other embodiments of the invention, the biofiller does not make the cellulose ester composition brittle.

In further embodiments of the invention, the inventive cellulose ester composition has a non-plastic texture mimicking a natural material such as wood. The examples have pictures that illustrate this property.

### Appearance

The appearance of an article comprising the melt processable cellulose ester composition is important to its acceptability in many applications. For example, a light color and transparency are desired properties for many melt-processed articles like packaging, bags, films, bottles, food containers, straws, stirrers, cups, plates, bowls, take out trays and lids and cutlery.

In CIE L*a*b* color space, the L* value is a measure of brightness, with L*=0 being black and L*=100 being white. Therefore, the color of an article can be considered light if the L* value is in the upper half of that range, or L*>50. In an embodiment of this invention, the L* of the cellulose ester composition can range from 50 to 100, 50 to 95, 50 to 90, 50 to 85, 50 to 80, 50 to 75, 55 to 100, 55 to 95, 55 to 90, 55 to 85, 55 to 80, 55 to 75, 60 to 100, 60 to 95, 60 to 90, 60 to 85, 60 to 80, 60 to 75, 65 to 100, 65 to 95, 65 to 90, 65 to 85, 65 to 80, or 65 to 75.

Opacity is the measure of light transmission through a film or article. Transparency refers to the optical distinctness with which an object can be seen when viewed through a film or sheet. The perceived opacity and transparency depend on the thickness of the sample. For the application examples above, article thickness can range from about 1 mil for packaging films up to 60 mil or greater for injection molded cutlery. Transparency may be especially important for viewing the contents of containers, such as through the side of a bottle or through a container lid. Melt-processed containers, cups and lids vary in thickness from about 10 mil to about 30 mil, while bottles are about 20 mil thick.

The boundaries between transparent, translucent and opaque are often highly subjective. In this study, opacity was measured as the % transmittance of light at 600 nm through a film 30 mil thick. In an embodiment of the invention, the % transmittance of the inventive cellulose ester composition can range from about 1% to about 100%, about 1% to about 90%, about 1% to about 80%, about 1% to about 70%, about 1% to about 60%, about 1% to about 50%, about 1% to about 40%, about 1% to about 30%, about 1% to about 20%, about 1% to about 10%, and about 1%.

Transparency was quantified as color difference, Delta E (CIE76). On a typical scale, the Delta E value will range from 0 to 100. The ability of the human eye to distinguish between two colors is related to Delta E; colors with a Delta E<1 are not perceptible as different. On the other hand, colors with a Delta E>10 are perceived as different at a glance. We used a Delta E cutoff of 20 to designate a readily perceived distinction between black and white as observed through a 30 mil extruded film. The formula for Delta E (CIE76):

$$Δ {E}_{ab}^{*} = \sqrt{{( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2}}$$

In an embodiment of this invention, the Delta E of the cellulose ester composition can range from about 20 to about 100.

### Other Elements of the Composition

In an aspect, the melt processable cellulose ester composition can further comprise at least one selected from the group consisting of a non-alkaline filler, additive, biopolymer, stabilizer, and/or odor modifier. Examples of additives include waxes, compatibilizers, biodegradation promoters, dyes, pigments, colorants, fragrances, luster control agents, lubricants, antioxidants, viscosity modifiers, antifungal agents, anti-fogging agents, flame retardants, heat stabilizers, impact modifiers, antibacterial agents, softening agents, mold release agents, and combinations thereof. It should be noted that the same type of compounds or materials can be identified for or included in multiple categories of components in the cellulose ester compositions. For example, polyethylene glycol (PEG) could function as a plasticizer or as an additive that does not function as a plasticizer, such as a hydrophilic polymer or biodegradation promotor, e.g., where a lower molecular weight PEG has a plasticizing effect and a higher molecular weight PEG functions as a hydrophilic polymer but without plasticizing effect.

In certain embodiments, the cellulose ester composition comprises at least one stabilizer. Although it is desirable for the cellulose ester composition to be composable and/or biodegradable, a certain amount of stabilizer may be added to provide a selected shelf life or stability, e.g., towards light exposure, oxidative stability, or hydrolytic stability. In various embodiments, stabilizers can include: UV absorbers, antioxidants (ascorbic acid, BHT, BHA, etc.), other acid and radical scavengers, epoxidized oils, e.g., epoxidized soybean oil, or combinations thereof.

Antioxidants can be classified into several classes, including primary antioxidant, and secondary antioxidant. Primary antioxidants are generally known to function essentially as free radical terminators (scavengers). Secondary antioxidants are generally known to decompose hydroperoxides (ROOH) into nonreactive products before they decompose into alkoxy and hydroxy radicals. Secondary antioxidants are often used in combination with free radical scavengers (primary antioxidants) to achieve a synergistic inhibition effect and secondary AOs are used to extend the life of phenolic type primary AOs.

“Primary antioxidants” are antioxidants that act by reacting with peroxide radicals via a hydrogen transfer to quench the radicals. Primary antioxidants generally contain reactive hydroxy or amino groups such as in hindered phenols and secondary aromatic amines. Examples of primary antioxidants include BHT, Irganox™ 1010, 1076, 1726, 245, 1098, 259, and 1425; Ethanox™ 310, 376, 314, and 330; Evernox™ 10, 76, 1335, 1330, 3114, MD 1024, 1098, 1726, 120. 2246, and 565; Anox™ 20, 29, 330, 70, IC-14, and 1315; Lowinox™ 520, 1790, 22IB46, 22M46, 44B25, AH25, GP45, CA22, CPL, HD98, TBM-6, and WSP; Naugard™ 431, PS48, SP, and 445; Songnox™ 1010, 1024, 1035, 1076 CP, 1135 LQ, 1290 PW, 1330FF, 1330 PW, 2590 PW, and 3114 FF; and ADK Stab AO-20, AO-30, AO-40, AO-50, AO-60, AO-80, and AO-330.

“Secondary antioxidants” are often called hydroperoxide decomposers. They act by reacting with hydroperoxides to decompose them into nonreactive and thermally stable products that are not radicals. They are often used in conjunction with primary antioxidants. Examples of secondary antioxidants include the organophosphorous (e.g., phosphites, phosphonites) and organosulfur classes of compounds. The phosphorous and sulfur atoms of these compounds react with peroxides to convert the peroxides into alcohols. Examples of secondary antioxidants include Ultranox 626, Ethanox™ 368, 326, and 327; Doverphos™ LPG11, LPG12, DP S-680, 4, 10, S480, S-9228, S-9228T; Evernox™ 168 and 626; Irgafos™ 126 and 168; Weston™ DPDP, DPP, EHDP, PDDP, TDP, TLP, and TPP; Mark™ CH 302, CH 55, TNPP, CH₆₆, CH 300, CH 301, CH 302, CH 304, and CH 305; ADK Stab 2112, HP-10, PEP-8, PEP-36, 1178, 135A, 1500, 3010, C, and TPP; Weston 439, DHOP, DPDP, DPP, DPTDP, EHDP, PDDP, PNPG, PTP, PTP, TDP, TLP, TPP, 398, 399, 430, 705, 705T, TLTTP, and TNPP; Alkanox 240, 626, 626A, 627AV, 618F, and 619F; and Songnox™ 1680 FF, 1680 PW, and 6280 FF.

In embodiments, the cellulose ester composition comprises at least one stabilizer, wherein the stabilizer comprises one or more secondary antioxidants. In embodiments, the stabilizer comprises a first stabilizer component chosen from one or more secondary antioxidants and a second stabilizer component chosen from one or more primary antioxidants, or a combination thereof.

In embodiments, the stabilizer comprises one or more secondary antioxidants in an amount in the range of from 0.01 to 0.8, or 0.01 to 0.7, or 0.01 to 0.5, or 0.01 to 0.4, or 0.01 to 0.3, or 0.01 to 0.25, or 0.01 to 0.2, or 0.05 to 0.8, or 0.05 to 0.7, or 0.05 to 0.5, or 0.05 to 0.4, or 0.05 to 0.3, or 0.05 to 0.25, or 0.05 to 0.2, or 0.08 to 0.8, or 0.08 to 0.7, or 0.08 to 0.5, or 0.08 to 0.4, or 0.08 to 0.3, or 0.08 to 0.25, or 0.08 to 0.2, in weight percent of the total amount of secondary antioxidants based on the total weight of the composition. In one class of this embodiment, the stabilizer comprises a secondary antioxidant that is a phosphite compound. In one class of this embodiment, the stabilizer comprises a secondary antioxidant that is a phosphite compound and another secondary antioxidant that is DLTDP.

In one subclass of this class, the stabilizer further comprises a second stabilizer component that comprises one or more primary antioxidants in an amount in the range of from 0.05 to 0.7, or 0.05 to 0.6, or 0.05 to 0.5, or 0.05 to 0.4, or 0.05 to 0.3, or 0.1 to 0.6, or 0.1 to 0.5, or 0.1 to 0.4, or 0.1 to 0.3, in weight percent of the total amount of primary antioxidants based on the total weight of the composition. In another subclass of this class, the stabilizer further comprises a second stabilizer component that comprises citric acid in an amount in the range of from 0.05 to 0.2, or 0.05 to 0.15, or 0.05 to 0.1 in weight percent of the total amount of citric acid based on the total weight of the composition. In another subclass of this class, the stabilizer further comprises a second stabilizer component that comprises one or more primary antioxidants and citric acid in the amounts discussed herein. In one subclass of this class, the stabilizer comprises less than 0.1 wt % or no primary antioxidants, based on the total weight of the composition. In one subclass of this class, the stabilizer comprises less than 0.05 wt % or no primary antioxidants, based on the total weight of the composition.

In embodiments, the cellulose ester composition comprises at least one non-alkaline filler. In embodiments, the other filler is at least one selected from the group consisting of carbohydrates (sugars and salts), cellulosic and organic fillers (wood flour, wood fibers, hemp, carbon, coal particles, graphite, and starches), mineral and inorganic fillers (talc, silica, silicates, titanium dioxide, glass fibers, glass spheres, boronitride, aluminum trihydrate, alumina, and clays), food wastes or byproduct (eggshells, distillers grain, and coffee grounds), desiccants (e.g. calcium sulfate, magnesium sulfate), alkaline fillers (e.g., CaO, Na₂CO₃), or combinations (e.g., mixtures) of these fillers. In embodiments, the cellulose ester compositions can include at least one filler that also functions as a colorant additive. In embodiments, the colorant additive filler can be chosen from: carbon, graphite, titanium dioxide, opacifiers, dyes, pigments, toners and combinations thereof. In embodiments, the cellulose ester compositions can include at least one filler that also functions as a stabilizer or flame retardant.

In embodiments, the cellulose ester composition further comprises at least one non-alkaline filler (as described herein) in an amount from 1 to 60 wt %, or 5 to 55 wt %, or 5 to 50 wt %, or 5 to 45 wt %, or 5 to 40 wt %, or 5 to 35 wt %, or 5 to 30 wt %, or 5 to 25 wt %, or 10 to 55 wt %, or 10 to 50 wt %, or 10 to 45 wt %, or 10 to 40 wt %, or 10 to 35 wt %, or 10 to 30 wt %, or 10 to 25 wt %, or 15 to 55 wt %, or 15 to 50 wt %, or 15 to 45 wt %, or 15 to 40 wt %, or 15 to 35 wt %, or 15 to 30 wt %, or 15 to 25 wt %, or 20 to 55 wt %, or 20 to 50 wt %, or 20 to 45 wt %, or 20 to 40 wt %, or 20 to 35 wt %, or 20 to 30 wt %, all based on the total weight of the cellulose ester composition. In embodiments, depending on the application, e.g., single use food contact applications, the cellulose ester composition can include at least one odor modifying additive. In embodiments, depending on the application and components used in the cellulose ester composition, suitable odor modifying additives can be chosen from: vanillin, Pennyroyal M-1178, almond, cinnamyl, spices, spice extracts, volatile organic compounds or small molecules, and Plastidor. In one embodiment, the odor modifying additive can be vanillin. In embodiments, the cellulose ester composition can include an odor modifying additive in an amount from 0.01 to 1 wt %, or 0.1 to 0.5 wt %, or 0.1 to 0.25 wt %, or 0.1 to 0.2 wt %, based on the total weight of the composition. Mechanisms for the odor modifying additives can include masking, capturing, complementing or combinations of these.

As discussed above, the cellulose ester composition can include other additives. In embodiments, the cellulose ester composition can include at least one compatibilizer. In embodiments, the compatibilizer can be either a non-reactive compatibilizer or a reactive compatibilizer. The compatibilizer can enhance the ability of the cellulose ester or another component to reach a desired small particle size to improve the dispersion of the chosen component in the composition. In such embodiments, depending on the desired formulation, the biodegradable cellulose ester can either be in the continuous or discontinuous phase of the dispersion. In embodiments, the compatibilizers used can improve mechanical and/or physical properties of the compositions by modifying the interfacial interaction/bonding between the biodegradable cellulose ester and another component, e.g., other biodegradable polymer.

In embodiments, the cellulose ester composition comprises a compatibilizer in an amount from about 1 to about 40 wt %, or about 1 to about 30 wt %, or about 1 to about 20 wt %, or about 1 to about 10 wt %, or about 5 to about 20 wt %, or about 5 to about 10 wt %, or about 10 to about 30 wt %, or about 10 to about 20 wt %, based on the weight of the cellulose ester composition.

In embodiments, if desired, the cellulose ester composition can include biodegradation and/or decomposition agents, e.g., hydrolysis assistant or any intentional degradation promoter additives can be added to or contained in the cellulose ester composition, added either during manufacture of the biodegradable cellulose ester (BCE) or subsequent to its manufacture and melt or solvent blended together with the BCE to make the cellulose ester composition. In embodiments, additives can promote hydrolysis by releasing acidic or basic residues, and/or accelerate photo (UV) or oxidative degradation and/or promote the growth of selective microbial colony to aid the disintegration and biodegradation in compost and soil medium. In addition to promoting degradation, these additives can have an additional function such as improving the processability of the article or improving desired mechanical properties.

One set of examples of possible decomposition agents include inorganic carbonate, synthetic carbonate, nepheline syenite, talc, aluminum hydroxide, diatomaceous earth, natural or synthetic silica, calcined clay, and the like. In embodiments, it may be desirable that these additives are dispersed well in the cellulose ester composition matrix. The additives can be used singly, or in a combination of two or more.

Another set of examples of possible decomposition agents are aromatic ketones used as an oxidative decomposition agent, including benzophenone, anthraquinone, anthrone, acetylbenzophenone, 4-octylbenzophenone, and the like. These aromatic ketones may be used singly, or in a combination of two or more.

Other examples include transition metal compounds used as oxidative decomposition agents, such as salts of cobalt or magnesium, e.g., aliphatic carboxylic acid (C12 to C20) salts of cobalt or magnesium, or cobalt stearate, cobalt oleate, magnesium stearate, and magnesium oleate; or anatase-form titanium dioxide, or titanium dioxide may be used. Mixed phase titanium dioxide particles may be used in which both rutile and anatase crystalline structures are present in the same particle. The particles of photoactive agent can have a relatively high surface area, for example from about 10 to about 300 sq. m/g, or from 20 to 200 sq. m/g, as measured by the BET surface area method. The photoactive agent can be added to the plasticizer if desired. These transition metal compounds can be used singly, or in a combination of two or more.

Examples of rare earth compounds that can used as oxidative decomposition agents include rare earths belonging to periodic table Group 3A, and oxides thereof. Specific examples thereof include cerium (Ce), yttrium (Y), neodymium (Nd), rare earth oxides, hydroxides, rare earth sulfates, rare earth nitrates, rare earth acetates, rare earth chlorides, rare earth carboxylates, and the like. More specific examples thereof include cerium oxide, ceric sulfate, ceric ammonium Sulfate, ceric ammonium nitrate, cerium acetate, lanthanum nitrate, cerium chloride, cerium nitrate, cerium hydroxide, cerium octylate, lanthanum oxide, yttrium oxide, Scandium oxide, and the like. These rare earth compounds may be used singly, or in a combination of two or more.

In one embodiment, the BCE composition includes an additive with pro-degradant functionality to enhance biodegradability that comprises an enzyme, a bacterial culture, a sugar, glycerol or other energy sources. The additive can also comprise hydroxylamine esters and thio compounds.

In certain embodiments, other possible biodegradation and/or decomposition agents can include swelling agents and disintegrants. Swelling agents can be hydrophilic materials that increase in volume after absorbing water and exert pressure on the surrounding matrix. Disintegrants can be additives that promote the breakup of a matrix into smaller fragments in an aqueous environment. Examples include minerals and polymers, including crosslinked or modified polymers and swellable hydrogels. In embodiments, the BCE composition may include water-swellable minerals or clays and their salts, such as laponite and bentonite; hydrophilic polymers, such as poly(acrylic acid) and salts, poly(acrylamide), poly(ethylene glycol) and poly(vinyl alcohol); polysaccharides and gums, such as starch, alginate, pectin, chitosan, psyllium, xanthan gum; guar gum, locust bean gum; and modified polymers, such as crosslinked PVP, sodium starch glycolate, carboxymethyl cellulose, gelatinized starch, croscarmellose sodium; or combinations of these additives.

Examples of other hydrophilic polymers or biodegradation promoters may include glycols, polyglycols, polyethers, and polyalcohols or other biodegradable polymers such as poly(glycolic acid), poly(lactic acid), polyethylene glycol, polypropylene glycol, polydioxanes, polyoxalates, poly(α-esters), polycarbonates, polyanhydrides, polyacetals, polycaprolactones, poly(orthoesters), polyamino acids, poly(hydroxyalkanoates), aliphatic polyesters such as poly(butylene) succinate, poly(ethylene) succinate, starch, regenerated cellulose, or aliphatic-aromatic polyesters such as PBAT, and co-polyesters of any of these.

In embodiments, examples of colorants can include carbon black, iron oxides such as red or blue iron oxides, titanium dioxide, silicon dioxide, cadmium red, calcium carbonate, kaolin clay, aluminum hydroxide, barium sulfate, zinc oxide, aluminum oxide, and organic pigments such as azo and diazo and triazo pigments, condensed azo, azo lakes, naphthol pigments, anthrapyrimidine, benzimidazolone, carbazole, diketopyrrolopyrrole, flavanthrone, indigoid pigments, isoindolinone, isoindoline, isoviolanthrone, metal complex pigments, oxazine, perylene, perinone, pyranthrone, pyrazoloquinazolone, quinophthalone, triarylcarbonium pigments, triphendioxazine, xanthene, thioindigo, indanthrone, isoindanthrone, anthanthrone, anthraquinone, isodibenzanthrone, triphendioxazine, quinacridone and phthalocyanine series, especially copper phthalocyanme and its nuclear halogenated derivatives, and also lakes of acid, basic and mordant dyes, and isoindolinone pigments, as well as plant and vegetable dyes, and any other available colorant or dye.

In embodiments, luster control agents for adjusting the glossiness and fillers can include silica, talc, clay, barium sulfate, barium carbonate, calcium sulfate, calcium carbonate, magnesium carbonate, and the like.

Suitable flame retardants can include silica, metal oxides, phosphates, catechol phosphates, resorcinol phosphates, borates, inorganic hydrates, and aromatic polyhalides.

Antifungal and/or antibacterial agents include polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Viscosity modifiers having the purpose of modifying the melt flow index or viscosity of the biodegradable cellulose ester composition that can be used include polyethylene glycols and polypropylene glycols, and glycerin.

In embodiments, other components that can be included in the BCE composition may function as release agents or lubricants (e.g. fatty acids, ethylene glycol distearate), anti-block or slip agents (e.g. fatty acid esters, metal stearate salts (for example, zinc stearate), and waxes), antifogging agents (e.g. surfactants), thermal stabilizers (e.g. epoxy stabilizers, derivatives of epoxidized soybean oil (ESBO), linseed oil, and sunflower oil), anti-static agents, foaming agents, biocides, impact modifiers, or reinforcing fibers. More than one component may be present in the BCE composition. It should be noted that an additional component may serve more than one function in the BCE composition. The different (or specific) functionality of any particular additive (or component) to the BCE composition can be dependent on its physical properties (e.g., molecular weight, solubility, melt temperature, Tg, etc.) and/or the amount of such additive/component in the overall composition. For example, polyethylene glycol can function as a plasticizer at one molecular weight or as a hydrophilic agent (with little or no plasticizing effect) at another molecular weight.

In embodiments, fragrances can be added if desired. Examples of fragrances can include spices, spice extracts, herb extracts, essential oils, smelling salts, volatile organic compounds, volatile small molecules, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, isoeugenol, cinnamaldehyde, ethyl maltol, vanilla, vanillin, cinnamyl alcohol, anisole, anethole, estragole, thymol, furaneol, methanol, rosemary, lavender, citrus, freesia, apricot blossoms, greens, peach, jasmine, rosewood, pine, thyme, oakmoss, musk, vetiver, myrrh, blackcurrant, bergamot, grapefruit, acacia, passiflora, sandalwood, tonka bean, mandarin, neroli, violet leaves, gardenia, red fruits, ylang-ylang, acacia farnesiana, mimosa, tonka bean, woods, ambergris, daffodil, hyacinth, narcissus, black currant bud, iris, raspberry, lily of the valley, sandalwood, vetiver, cedarwood, neroli, strawberry, carnation, oregano, honey, civet, heliotrope, caramel, coumarin, patchouli, dewberry, helonial, coriander, pimento berry, labdanum, cassie, aldehydes, orchid, amber, orris, tuberose, palmarosa, cinnamon, nutmeg, moss, styrax, pineapple, foxglove, tulip, wisteria, clematis, ambergris, gums, resins, civet, plum, castoreum, civet, myrrh, geranium, rose violet, jonquil, spicy carnation, galbanum, petitgrain, iris, honeysuckle, pepper, raspberry, benzoin, mango, coconut, hesperides, castoreum, osmanthus, mousse de chene, nectarine, mint, anise, cinnamon, orris, apricot, plumeria, marigold, rose otto, narcissus, tolu balsam, frankincense, amber, orange blossom, bourbon vetiver, opopanax, white musk, papaya, sugar candy, jackfruit, honeydew, lotus blossom, muguet, mulberry, absinthe, ginger, juniper berries, spicebush, peony, violet, lemon, lime, hibiscus, white rum, basil, lavender, balsamics, fo-ti-tieng, osmanthus, karo karunde, white orchid, calla lilies, white rose, rhubrum lily, tagetes, ambergris, ivy, grass, seringa, spearmint, clary sage, cottonwood, grapes, brimbelle, lotus, cyclamen, orchid, glycine, tiare flower, ginger lily, green osmanthus, passion flower, blue rose, bay rum, cassie, African tagetes, Anatolian rose, Auvergne narcissus, British broom, British broom chocolate, Bulgarian rose, Chinese patchouli, Chinese gardenia, Calabrian mandarin, Comoros Island tuberose, Ceylonese cardamom, Caribbean passion fruit, Damascena rose, Georgia peach, white Madonna lily, Egyptian jasmine, Egyptian marigold, Ethiopian civet, Farnesian cassie, Florentine iris, French jasmine, French jonquil, French hyacinth, Guinea oranges, Guyana wacapua, Grasse petitgrain, Grasse rose, Grasse tuberose, Haitian vetiver, Hawaiian pineapple, Israeli basil, Indian sandalwood, Indian Ocean vanilla, Italian bergamot, Italian iris, Jamaican pepper, May rose, Madagascar ylang-ylang, Madagascar vanilla, Moroccan jasmine, Moroccan rose, Moroccan oakmoss, Moroccan orange blossom, Mysore sandalwood, Oriental rose, Russian leather, Russian coriander, Sicilian mandarin, South African marigold, South American tonka bean, Singapore patchouli, Spanish orange blossom, Sicilian lime, Reunion Island vetiver, Turkish rose, Thai benzoin, Tunisian orange blossom, Yugoslavian oakmoss, Virginian cedarwood, Utah yarrow, West Indian rosewood, and the like, and any combination thereof.

In embodiments, the cellulose ester composition and any article made from or comprising such composition comprises biodegradable cellulose ester (BCE) that contains some recycle content. In embodiments, the recycle content is provided by a reactant derived from recycled material that is the source of one or more acetyl groups on the BCE. In embodiments, the reactant is derived from recycled plastic. In embodiments, the reactant is derived from recycled plastic content syngas. By “recycled plastic content syngas” is meant syngas obtained from a synthesis gas operation utilizing a feedstock that contains at least some content of recycled plastics, as described in the various embodiments more fully herein below. In embodiments, the recycled plastic content syngas can be made in accordance with any of the processes for producing syngas described herein; can comprise, or consist of, any of the syngas compositions or syngas composition streams described herein; or can be made from any of the feedstock compositions described herein.

In embodiments, the feedstock (for the synthesis gas operation) can be in the form of a combination of one or more particulated fossil fuel sources and particulated recycled plastics. In one embodiment or in any of the mentioned embodiments, the solid fossil fuel source can include coal. In embodiments, the feedstock is fed to a gasifier along with an oxidizer gas, and the feedstock is converted to syngas.

In embodiments, the recycled plastic content syngas is utilized to make at least one chemical intermediate in a reaction scheme to make a Recycle BCE. In embodiments, the recycled plastic content syngas can be a component of feedstock (used to make at least one CA intermediate) that includes other sources of syngas, hydrogen, carbon monoxide, or combinations thereof. In one embodiment or in any of the mentioned embodiments, the only source of syngas used to make the CA intermediates is the recycled plastic content syngas.

In embodiments, the CA intermediates made using the recycled content syngas, e.g., recycled plastic content syngas, can be chosen from methanol, acetic acid, methyl acetate, acetic anhydride and combinations thereof. In embodiments, the CA intermediates can be a at least one reactant or at least one product in one or more of the following reactions: (1) syngas conversion to methanol; (2) syngas conversion to acetic acid; (3) methanol conversion to acetic acid, e.g., carbonylation of methanol to produce acetic acid; (4) producing methyl acetate from methanol and acetic acid; and (5) conversion of methyl acetate to acetic anhydride, e.g., carbonylation of methyl acetate and methanol to acetic acid and acetic anhydride.

In embodiments, recycled plastic content syngas is used to produce at least one cellulose reactant. In embodiments, the recycled plastic content syngas is used to produce at least one Recycle BCE.

In embodiments, the recycled plastic content syngas is utilized to make acetic anhydride. In embodiments, syngas that comprises recycled plastic content syngas is first converted to methanol and this methanol is then used in a reaction scheme to make acetic anhydride. “RPS acetic anhydride” refers to acetic anhydride that is derived from recycled plastic content syngas. Derived from means that at least some of the feedstock source material (that is used in any reaction scheme to make a CA intermediate) has some content of recycled plastic content syngas.

In embodiments, the RPS acetic anhydride is utilized as a CA intermediate reactant for the esterification of cellulose to prepare a Recycle BCE, as discussed more fully above. In embodiments, the RPS acetic acid is utilized as a reactant to prepare cellulose ester or cellulose diacetate.

In embodiments, the Recycle CA is prepared from a cellulose reactant that comprises acetic anhydride that is derived from recycled plastic content syngas.

In embodiments, the recycled plastic content syngas comprises gasification products from a gasification feedstock. In an embodiment, the gasification products are produced by a gasification process using a gasification feedstock that comprises recycled plastics. In embodiments, the gasification feedstock comprises coal.

In embodiments, the gasification feedstock comprises a liquid slurry that comprises coal and recycled plastics. In embodiments, the gasification process comprises gasifying the gasification feedstock in the presence of oxygen.

In one aspect, a Recycle BCE composition is provided that comprises at least one biodegradable cellulose ester having at least one substituent on an anhydroglucose unit (AGU) derived from one or more chemical intermediates, at least one of which is obtained at least in part from recycled plastic content syngas.

In embodiments, the Recycle BCE is biodegradable and contains content derived from a renewable source, e.g., cellulose from wood or cotton linter, and content derived from a recycled material source, e.g., recycled plastics. Thus, in embodiments, a melt processible material is provided that is biodegradable and contains both renewable and recycled content, i.e., made from renewable and recycled sources.

In another aspect, a Cellulose ester composition is provided that comprises Recycle BCE prepared by an integrated process which comprises the processing steps of: (1) preparing a recycled plastic content syngas in a synthesis gas operation utilizing a feedstock that contains a solid fossil fuel source and at least some content of recycled plastics; (2) preparing at least one chemical intermediate from the syngas; (3) reacting the chemical intermediate in a reaction scheme to prepare at least one cellulose reactant for preparing a Recycle BCE, and/or selecting the chemical intermediate to be at least one cellulose reactant for preparing a Recycle BCE; and (4) reacting the at least one cellulose reactant to prepare the Recycle BCE; wherein the Recycle BCE comprises at least one substituent on an anhydroglucose unit (AGU) derived from recycled plastic content syngas.

In embodiments, the processing steps (1) to (4) are carried out in a system that is in fluid and/or gaseous communication (i.e., including the possibility of a combination of fluid and gaseous communication). It should be understood that the chemical intermediates, in one or more of the reaction schemes for producing Recycle BCEs starting from recycled plastic content syngas, may be temporarily stored in storage vessels and later reintroduced to the integrated process system.

In embodiments, the at least one chemical intermediate is chosen from methanol, methyl acetate, acetic anhydride, acetic acid, or combinations thereof. In embodiments, one chemical intermediate is methanol, and the methanol is used in a reaction scheme to make a second chemical intermediate that is acetic anhydride. In embodiments, the cellulose reactant is acetic anhydride.

The biodegradable cellulose ester useful in embodiments of the present invention can have a degree of substitution in the range of from 1.0 to 2.5. In some cases, the cellulose ester as described herein may have an average degree of substitution of at least about 1.0, 1.05, 1.1, 1.15, 1.2, 1.25, 1.3, 1.35, 1.4, 1.45 or 1.5 and/or not more than about 2.5, 2.45, 2.4, 2.35, 2.3, 2.25, 2.2, 2.15, 2.1, 2.05, 2.0, 1.95, 1.9, 1.85, 1.8 or 1.75. In one embodiment or in combination with any other embodiment, the cellulose ester has a degree of substitution for hydroxyl that is from 0.6 to 0.9, or from 0.7 to 0.9, or from 0.8 to 0.9, or form 0.8 to 0.9.

In one embodiment or in combination with any other embodiment, the biodegradable cellulose ester may have a number average molecular weight (Mn) of not more than 100,000, or not more than 90,000, measured using gel permeation chromatography with a polystyrene equivalent and using N-methyl-2-pyrrolidone (NMP) as the solvent. In some cases, the biodegradable cellulose ester may have a Mn of at least about 10,000, at least about 20,000, 25,000, 30,000, 35,000, 40,000, or 45,000 and/or not more than about 100,000, 95,000, 90,000, 85,000, 80,000, 75,000, 70,000, 65,000, 60,000, or 50,000.

### Biodegradation and Disintegration

In embodiments, the BCE containing article can be biodegradable and have a certain degree of disintegration. Biodegradation refers to mineralization of a substance, or conversion to biomass, CO₂ and water by the action of microbial metabolism. In contrast, disintegration refers to the visible breakdown of a material, often through the combined action of physical, chemical and biological mechanisms.

In an embodiment of this invention, the melt processable cellulose ester compositions show improved disintegration compared with formulations without the biofiller. The improvement may be measured as disintegration of thicker parts in the same amount of time, or it may refer to faster rate of disintegration. The degree of disintegration can be characterized by the weight loss of a sample over a given period of exposure to certain environmental conditions. In some cases, the BCE composition can exhibit a weight loss of at least about 5, 10, 15, or 20 percent after burial in soil for 60 days and/or a weight loss of at least about 15, 20, 25, 30, or 35 percent after 15 days of exposure to a typical municipal composter. However, the rate of degradation may vary depending on the particular end use of the article, as well as the composition of the article, and the specific test. Exemplary test conditions are provided in U.S. Pat. Nos. 5,970,988 and 6,571,802.

In some embodiments, the BCE composition may be in the form of biodegradable single use (formed/molded) articles. It has been found that BCE compositions as described herein can exhibit enhanced levels of environmental non-persistence, characterized by better-than-expected degradation under various environmental conditions. BCE containing articles described herein may meet or exceed passing standards set by international test methods and authorities for industrial compostability, home compostability, and/or soil biodegradability.

Disintegration refers to the physical breakdown of a material. Disintegration of a material may be influenced by biological, chemical and/or physical processes. Methods to monitor disintegration during composting may be performed in synthetic compost under standardized lab conditions, or as a field test in an authentic industrial or home compost system. Standardized methods to monitor disintegration in industrial compost are defined in ISO-20200 and ISO-16929. Qualitative screening tests may also be based on these standardized tests.

Home composting can be simulated under lab conditions, for example, by running ISO-16929 or ISO-20200 at lower temperatures, or by monitoring the disintegration of test materials in a home composting vessel. Home composting may also be conducted under conditions similar to those described in the standardized methods but conducted at larger scale in outdoor domestic composting bins.

To be considered “compostable,” a material must meet the following four criteria: (1) the material should pass biodegradation requirement in a test under controlled composting conditions at elevated temperature (58° C.) according to ISO 14855-1 (2012) which correspond to an absolute 90% biodegradation or a relative 90% to a control polymer, (2) the material tested under aerobic composting condition according to ISO16929 (2013) or ISO20200 must reach a 90% disintegration; (3) the test material must fulfill all the requirements on volatile solids, heavy metals and fluorine as stipulated by ASTM D6400 (2012), EN 13432 (2000) and ISO 17088 (2012); and (4) the material should not cause negative on plant growth. As used herein, the term “biodegradable” generally refers to the biological conversion and consumption of organic molecules. Biodegradability is an intrinsic property of the material itself, and the material can exhibit different degrees of biodegradability, depending on the specific conditions to which it is exposed. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

The cellulose ester composition (or article comprising same) can exhibit a biodegradation of at least 70 percent in a period of not more than 50 days, when tested under aerobic composting conditions at ambient temperature (28° C.±2° C.) according to ISO 14855-1 (2012). In some cases, the cellulose ester composition (or article comprising same) can exhibit a biodegradation of at least 70 percent in a period of not more than 49, 48, 47, 46, 45, 44, 43, 42, 41, 40, 39, 38, or 37 days when tested under these conditions, also called “home composting conditions.” These conditions may not be aqueous or anaerobic. In some cases, the cellulose ester composition (or article comprising same) can exhibit a total biodegradation of at least about 71, 72, 73, 74, 75, 76, 77, 78, 79, 80, 81, 82, 83, 84, 85, 86, 87, or 88 percent, when tested under according to ISO 14855-1 (2012) for a period of 50 days under home composting conditions. This may represent a relative biodegradation of at least about 95, 97, 99, 100, 101, 102, or 103 percent, when compared to cellulose subjected to identical test conditions.

To be considered “biodegradable,” under home composting conditions according to the French norm NF T 51-800 and the Australian standard AS 5810, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradation under home compositing conditions is 1 year. The cellulose ester composition as described herein may exhibit a biodegradation of at least 90 percent within not more than 1 year, measured according 14855-1 (2012) under home composting conditions. In some cases, the cellulose ester composition (or article comprising same) may exhibit a biodegradation of at least about 91, 92, 93, 94, 95, 96, 97, 98, 99, or 99.5 percent within not more than 1 year, or cellulose ester composition (or article comprising same) may exhibit 100 percent biodegradation within not more than 1 year, measured according 14855-1 (2012) under home composting conditions.

Additionally, or in the alternative, the cellulose ester composition (or article comprising same) described herein may exhibit a biodegradation of at least 90 percent within not more than about 350, 325, 300, 275, 250, 225, 220, 210, 200, 190, 180, 170, 160, 150, 140, 130, 120, 110, 100, 90, 80, 70, 60, or 50 days, measured according 14855-1 (2012) under home composting conditions. In some cases, the cellulose ester composition (or article comprising same) can be at least about 97, 98, 99, or 99.5 percent biodegradable within not more than about 70, 65, 60, or 50 days of testing according to ISO 14855-1 (2012) under home composting conditions. As a result, the cellulose ester composition (or article comprising same) may be considered biodegradable according to, for example, French Standard NF T 51-800 and Australian Standard AS 5810 when tested under home composting conditions.

The cellulose ester composition (or article comprising same) can exhibit a biodegradation of at least 60 percent in a period of not more than 45 days, when tested under aerobic composting conditions at a temperature of 58° C. (+2° C.) according to ISO 14855-1 (2012). In some cases, the cellulose ester composition (or article comprising same) can exhibit a biodegradation of at least 60 percent in a period of not more than 44, 43, 42, 41, 40, 39, 38, 37, 36, 35, 34, 33, 32, 31, 30, 29, 28, or 27 days when tested under these conditions, also called “industrial composting conditions.” These may not be aqueous or anaerobic conditions. In some cases, the cellulose ester composition (or article comprising same) can exhibit a total biodegradation of at least about 65, 70, 75, 80, 85, 87, 88, 89, 90, 91, 92, 93, 94, or 95 percent, when tested under according to ISO 14855-1 (2012) for a period of 45 days under industrial composting conditions. This may represent a relative biodegradation of at least about 95, 97, 99, 100, 102, 105, 107, 110, 112, 115, 117, or 119 percent, when compared to the same cellulose ester composition (or article comprising same) subjected to identical test conditions.

To be considered “biodegradable,” under industrial composting conditions according to ASTM D6400 and ISO 17088, at least 90 percent of the organic carbon in the whole item (or for each constituent present in an amount of more than 1% by dry mass) must be converted to carbon dioxide by the end of the test period when compared to the control or in absolute. According to European standard ED 13432 (2000), a material must exhibit a biodegradation of at least 90 percent in total, or a biodegradation of at least 90 percent of the maximum degradation of a suitable reference material after a plateau has been reached for both the reference and test item. The maximum test duration for biodegradability under industrial compositing conditions is 180 days. The cellulose ester composition (or article comprising same) described herein may exhibit a biodegradation of at least 90 percent within not more than 180 days, measured according to ISO14855-1 (2012) under industrial composting conditions. In some cases, the cellulose ester composition (or article comprising same) may exhibit a biodegradation of at least about 91, 92, 93, 94, 95, 96, 97, 98, 99, or 99.5 percent within not more than 180 days, or cellulose ester composition (or article comprising same) may exhibit 100 percent biodegradation within not more than 180 days, measured according to ISO 14855-1 (2012) under industrial composting conditions.

Additionally, or in the alternative, cellulose ester composition (or article comprising same) described herein may exhibit a biodegradation of least 90 percent within not more than about 175, 170, 165, 160, 155, 150, 145, 140, 135, 130, 125, 120, 115, 110, 105, 100, 95, 90, 85, 80, 75, 70, 65, 60, 55, 50, or 45 days, measured according to ISO 14855-1 (2012) under industrial composting conditions. In some cases, the cellulose ester composition (or article comprising same) can be at least about 97, 98, 99, or 99.5 percent biodegradable within not more than about 65, 60, 55, 50, or 45 days of testing according to ISO 14855-1 (2012) under industrial composting conditions. As a result, the cellulose ester composition (or article comprising same) described herein may be considered biodegradable according to ASTM D6400 and ISO 17088 when tested under industrial composting conditions.

The cellulose ester composition (or article comprising same) may exhibit a biodegradation in soil of at least 60 percent within not more than 130 days, measured according to ISO 17556 (2012) under aerobic conditions at ambient temperature. In some cases, cellulose ester composition (or article comprising same) can exhibit a biodegradation of at least 60 percent in a period of not more than 130, 120, 110, 100, 90, 80, or 75 days when tested under these conditions, also called “soil composting conditions.” These may not be aqueous or anaerobic conditions. In some cases, the cellulose ester composition (or article comprising same) can exhibit a total biodegradation of at least about 65, 70, 72, 75, 77, 80, 82, or 85 percent, when tested under according to ISO 17556 (2012) for a period of 195 days under soil composting conditions. This may represent a relative biodegradation of at least about 70, 75, 80, 85, 90, or 95 percent, when compared to the same cellulose ester composition (or article comprising same) subjected to identical test conditions.

In order to be considered “biodegradable,” under soil composting conditions according the OK biodegradable SOIL conformity mark of Vinçotte and the DIN Geprüft Biodegradable in soil certification scheme of DIN CERTCO, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradability under soil compositing conditions is 2 years.

The cellulose ester composition (or article comprising same) as described herein may exhibit a biodegradation of at least 90 percent within not more than 2 years, 1.75 years, 1 year, 9 months, or 6 months measured according to ISO 17556 (2012) under soil composting conditions. In some cases, the cellulose ester composition (or article comprising same) may exhibit a biodegradation of at least about 91, 92, 93, 94, 95, 96, 97, 98, 99, or 99.5 percent within not more than 2 years, or cellulose ester composition (or article comprising same) may exhibit 100 percent biodegradation within not more than 2 years, measured according to ISO 17556 (2012) under soil composting conditions.

Additionally, or in the alternative, cellulose ester composition (or article comprising same) described herein may exhibit a biodegradation of at least 90 percent within not more than about 700, 650, 600, 550, 500, 450, 400, 350, 300, 275, 250, 240, 230, 220, 210, 200, or 195 days, measured according to ISO 17556 (2012) under soil composting conditions. In some cases, the cellulose ester composition (or article comprising same) can be at least about 97, 98, 99, or 99.5 percent biodegradable within not more than about 225, 220, 215, 210, 205, 200, or 195 days of testing according to ISO 17556 (2012) under soil composting conditions. As a result, the cellulose ester composition (or article comprising same) described herein may meet the requirements to receive The OK biodegradable SOIL conformity mark of Vinçotte and to meet the standards of the DIN Geprüft Biodegradable in soil certification scheme of DIN CERTCO.

In some embodiments, cellulose ester composition (or article comprising same) of the present invention may include less than 1, 0.75, 0.50, or 0.25 weight percent of components of unknown biodegradability. In some cases, the cellulose ester composition (or article comprising same) described herein may include no components of unknown biodegradability.

Aquatic Biodegradation Test-02 Consumption (OECD 301F) may be used to monitor biodegradation of polymeric materials. OECD 301F is an aquatic aerobic biodegradation test that determines the biodegradability of a material by measuring oxygen consumption. OECD 301F is most often used for insoluble and volatile materials. The purity or proportions of major components of the test material is important for calculating the Theoretical Oxygen Demand (ThOD). Similar to other 301 test methods, the standard test duration for OECD 301F is a minimum of 28 days. A solution, or suspension, of the test substance in a mineral medium is inoculated and incubated under aerobic conditions in the dark or in diffuse light. Cellulose is run in parallel as the positive control to check the operation of the procedures.

Aquatic biodegradation is another measure of the biodegradability of a material of blend of substances. Biological Oxygen Demand [BOD] was measured over time using an OxiTop® Control OC 110 Respirometer system. This is accomplished by measuring the negative pressure that develops when oxygen is consumed in the closed bottle system. NaOH tablets are added to the system to collect the CO₂ given off when 02 is consumed. The CO₂ and NaOH react to form Na₂CO₃, which pulls CO₂ out of the gas phase and causes a measurable negative pressure. The OxiTop measuring heads record this negative pressure value and relay the information wirelessly to a controller, which converts CO₂ produced into BOD due to the 1:1 ratio. The measured biological oxygen demand can be compared to the theoretical oxygen demand of each test material to determine the percentage of biodegradation. In an embodiment of this invention, the Aquatic Biodegradation rate may be the same or different when the biofiller is included in a blend.

In addition to being biodegradable under industrial and/or home composting conditions, cellulose ester composition (or article comprising same) as described herein may also be compostable under home and/or industrial conditions. As described previously, a material is considered compostable if it meets or exceeds the requirements set forth in EN 13432 for biodegradability, ability to disintegrate, heavy metal content, and ecotoxicity. The cellulose ester composition (or article comprising same) described herein may exhibit sufficient compostability under home and/or industrial composting conditions to meet the requirements to receive the OK compost and OK compost HOME conformity marks from Vinçotte.

In some cases, the cellulose ester composition (or article comprising same) described herein may have a volatile solids concentration, heavy metals and fluorine content that fulfill all of the requirements laid out by EN 13432 (2000). Additionally, the cellulose ester composition (or article comprising same) may not cause a negative effect on compost quality (including chemical parameters and ecotoxicity tests).

In some cases, the cellulose ester composition (or article comprising same) can exhibit a disintegration of at least 90 percent within not more than 26 weeks, measured according to ISO 16929 (2013) or ISO 20200 under industrial composting conditions. In some cases, the cellulose ester composition (or article comprising same) may exhibit a disintegration of at least about 91, 92, 93, 94, 95, 96, 97, 98, 99, or 99.5 percent under industrial composting conditions within not more than 26 weeks, or cellulose ester composition (or article comprising same) may be 100 percent disintegrated under industrial composting conditions within not more than 26 weeks. Alternatively, or in addition, the cellulose ester composition (or article comprising same) may exhibit a disintegration of at least 90 percent under industrial compositing conditions within not more than about 26, 25, 24, 23, 22, 21, 20, 19, 18, 17, 16, 15, 14, 13, 12, 11, or 10 weeks, measured according to ISO 16929 (2013) or ISO 20200. In some cases, the cellulose ester composition (or article comprising same) described herein may be at least 97, 98, 99, or 99.5 percent disintegrated within not more than 12, 11, 10, 9, or 8 weeks under industrial composting conditions, measured according to ISO 16929 (2013) or ISO 20200.

In some cases, the cellulose ester composition (or article comprising same) can exhibit a disintegration of at least 90 percent within not more than 26 weeks, measured according to ISO 16929 (2013) or ISO 20200 under home composting conditions. In some cases, the cellulose ester composition (or article comprising same) may exhibit a disintegration of at least about 91, 92, 93, 94, 95, 96, 97, 98, 99, or 99.5 percent under home composting conditions within not more than 26 weeks, or the cellulose ester composition (or article comprising same) may be 100 percent disintegrated under home composting conditions within not more than 26 weeks. Alternatively, or in addition, the cellulose ester composition (or article comprising same) may exhibit a disintegration of at least 90 percent within not more than about 26, 25, 24, 23, 22, 21, 20, 19, 18, 17, 16, or 15 weeks under home composting conditions, measured according to ISO 16929 (2013) or ISO 20200. In some cases, the cellulose ester composition (or article comprising same) described herein may be at least 97, 98, 99, or 99.5 percent disintegrated within not more than 20, 19, 18, 17, 16, 15, 14, 13, or 12 weeks, measured under home composting conditions according to ISO 16929 (2013) or ISO 20200.

In embodiments or in combination with any other embodiments, when the cellulose ester composition is formed into a film or injection molded into an article having a maximum thickness of 0.02, or 0.05, or 0.07, or 0.10, or 0.13, or 0.25. or 0.38, or 0.51, or 0.64, or 0.76, or 0.89, or 1.02, or 1.14, or 1.27, or 1.40, or 1.52, or 1.78, or 2.0, or 2.3, or 2.5, or 3.0, or 3.3, or 3.8 mm, the film or article exhibits greater than 90% disintegration after 12 weeks according to Disintegration Test Protocol, as described in the specification or in the alternative according to ISO 16929 (2013) or ISO 20200. In certain embodiments, when the cellulose ester composition is formed into a film or injection molded into an article having a maximum thickness of 0.02, or 0.05, or 0.07, or 0.10, or 0.13, or 0.25. or 0.38, or 0.51, or 0.64, or 0.76, or 0.89, or 1.02, or 1.14, or 1.27, or 1.40, or 1.52, or 1.78, or 2.0, or 2.3, or 2.5, or 3.0, or 3.3, or 3.8 mm, the film or article exhibits greater than 90% disintegration after 12 weeks according to Disintegration Test Protocol, as described in the specification or in the alternative according to ISO (2013) or ISO 20200. In certain embodiments, when the cellulose ester composition is formed into a film having a thickness of 0.13, or 0.25. or 0.38, or 0.51, or 0.64, or 0.76, or 0.89, or 1.02, or 1.14, or 1.27, or 1.40, or 1.52 mm, the film exhibits greater than 90, or 95, or 96, or 97, or 98, or 99% disintegration after 12 weeks according to Disintegration Test Protocol, as described in the specification or in the alternative according to ISO 16929 (2013) or ISO 20200. In certain embodiments, when the cellulose ester composition is formed into a film or injection molded into an article having a maximum thickness of 0.02, or 0.05, or 0.07, or 0.10, or 0.13, or 0.25. or 0.38, or 0.51, or 0.64, or 0.76, or 0.89, or 1.02, or 1.14, or 1.27, or 1.40, or 1.52, or 1.78, or 2.0, or 2.3, or 2.5, or 3.0, or 3.3, or 3.8 mm, the film or article exhibits greater than 90, or 95, or 96, or 97, or 98, or 99% disintegration after 8, or 9, or 10, or 11, or 12, or 13, or 14, or 15, or 16 weeks according to Disintegration Test Protocol, as described in the specification or in the alternative according to ISO 16929 (2013) or ISO 20200.

In some embodiments, the cellulose ester composition (or article comprising same) described herein may be substantially free of photodegradation agents. For example, the cellulose ester composition (or article comprising same) may include not more than about 1, 0.75, 0.50, 0.25, 0.10, 0.05, 0.025, 0.01, 0.005, 0.0025, or 0.001 weight percent of photodegradation agent, based on the total weight of the cellulose ester composition (or article comprising same), or the cellulose ester composition (or article comprising same) may include no photodegradation agents. Examples of such photodegradation agents include, but are not limited to, pigments which act as photooxidation catalysts and are optionally augmented by the presence of one or more metal salts, oxidizable promoters, and combinations thereof. Pigments can include coated or uncoated anatase or rutile titanium dioxide, which may be present alone or in combination with one or more of the augmenting components such as, for example, various types of metals. Other examples of photodegradation agents include benzoins, benzoin alkyl ethers, benzophenone and its derivatives, acetophenone and its derivatives, quinones, thioxanthones, phthalocyanine and other photosensitizers, ethylene-carbon monoxide copolymer, aromatic ketone-metal salt sensitizers, and combinations thereof.

### End Uses

In an aspect, biodegradable, disintegrable, and/or compostable articles are provided that comprise the cellulose ester compositions, as described herein. In embodiments, the cellulose ester compositions can be extrudable, moldable, castable, thermoformable, or can be 3D printed.

In embodiments, the cellulose ester composition is melt-processable and can be formed into useful molded articles, e.g., single use food contact articles, that are biodegradable and/or compostable. In embodiments, the articles are non-persistent. By environmentally “non-persistent” is meant that when biodegradable cellulose ester reaches an advanced level of disintegration, it becomes amenable to total consumption by the natural microbial population. The degradation of biodegradable cellulose ester ultimately leads its conversion to carbon dioxide, water and biomass. In embodiments, articles comprising the cellulose ester compositions (discussed herein) are provided that have a maximum thickness up to 150 mils, or 140 mils, or 130 mils, or 120 mils, or 110 mils, or 100 mils, or 90 mils, or 80 mils, or 70 mils, or 60 mils, or 50 mils, or 40 mils, or 30 mils, or 25 mils, or 20 mils, or 15 mils, or 10 mils, or 5 mils or 2 mils or 1 mil, and are biodegradable and compostable (i.e., either pass industrial or home compostability tests/criterial as discussed herein). In embodiments, articles comprising the cellulose ester compositions (discussed herein) are provided that have a maximum thickness up to 150 mils, or 140 mils, or 130 mils, or 120 mils, or 110 mils, to 100 mils, or 90 mils, or 80 mils, or 70 mils, or 60 mils, or 50 mils, or 40 mils, or 30 mils, or 25 mils, or 20 mils, or 15 mils, or 10 mils, or 5 mils, or 2 mils, or 1 mil, and are environmentally non-persistent.

In embodiment of this invention, articles comprising the cellulose ester composition is provided wherein the article is used in food service and grocery items, horticulture, agriculture, recreation, coatings, fibers, nonwovens, and home/office applications. Example of food service, and grocery items include, but are not limited to, straws, cup lids, composite lids, portion cups, beverage cups, trays, bowl, plates, food containers, container lids, clamshell containers, cutlery, utensils, stirrers, jars, jar lids, bottles, bottle caps, bags, flexible packaging, wrap, produce baskets, produce stickers, and twine. Examples of horticulture and/or agriculture uses include, but are not limited to, plant pots, germination trays, transplant pots, plant tags, buckets, bags for soil & mulch, trimmer string, agricultural film, mulch film, greenhouse film, silage film, compostable bags, film stakes, hay baling twine. Examples of recreation articles include, but are not limited to, toys, sporting goods, fishing tackle, golf gear, and camping goods. Toys can include, but are not limited to, beach toys, blocks, wheels, propellers, sippy cups, doll accessories, and pet toys. Sporting goods can include, but are not limited to, whistles, whiffle balls, paddles, nets, foam balls & darts, and artificial turf). Fishing tackle can include, but are not limited to, floats, lures, nets, and traps. Golf gear includes, but is not limited to, tees, practice balls, ball markers, divot tools. Camping gear includes, but is not limited it, tent stakes, eating utensils, and cord/rope). Examples of home and office articles include, but are not limited to, gift cards, credit cards, signs, labels, report covers, mailers, tape, tool handles, toothbrush handles, writing utensils, combs, film canisters, wire insulation, screw caps, and bottles.

In embodiments, the articles are made from moldable thermoplastic material comprising the cellulose ester compositions, as described herein.

In embodiments, the articles are single use food contact articles. Examples of such articles that can be made with the cellulose ester compositions include cups, trays, multi-compartment trays, clamshell packaging, candy sticks, films, sheets, trays and lids (e.g., thermoformed), straws, plates, bowls, portion cups, food packaging, liquid carrying containers, solid or gel carrying containers, and cutlery. In embodiments, the cellulose ester may be a coating or layer of an article. The articles may comprise fibers. In embodiments, the articles can be horticultural articles. Examples of such articles that can be made with the cellulose ester compositions include plant pots, plant tags, mulch films, and agricultural ground cover.

In one embodiment or in combination with any other embodiment, the cellulose ester has a number average molecular weight (“Mn”) in the range of from 10,000 to 90,000 Daltons, as measured by GPC. In one embodiment or in combination with any other embodiment, the cellulose ester has a number average molecular weight (“Mn”) in the range of from 30,000 to 90,000 Daltons, as measured by GPC. In one embodiment or in combination with any other embodiment, the cellulose ester has a number average molecular weight (“Mn”) in the range of from 40,000 to 90,000 Daltons, as measured by GPC.

In one embodiment or in combination with any other embodiment, wherein when the composition is formed into a film having a thickness of 0.38 mm, the film exhibits greater than 5% disintegration after 6 weeks and greater than 90% disintegration after 12 weeks according to the Disintegration Test Protocol, as described in the specification or in the alternative according to ISO 16929 (2013) or ISO 20200. In one embodiment or in combination with any other embodiment, wherein when the composition is formed into a film having a thickness of 0.38 mm, the film exhibits greater than 10% disintegration after 6 weeks and greater than 90% disintegration after 12 weeks according to Disintegration Test Protocol, as described in the specification or in the alternative according to ISO 16929 (2013) or ISO 20200. In one embodiment or in combination with any other embodiment, wherein when the composition is formed into a film having a thickness of 0.38 mm, the film exhibits greater than 20% disintegration after 6 weeks and greater than 90% disintegration after 12 weeks according to Disintegration Test Protocol, as described in the specification or in the alternative according to ISO 16929 (2013) or ISO 20200. In one embodiment or in combination with any other embodiment, wherein when the composition is formed into a film having a thickness of 0.38 mm, the film exhibits greater than 30% disintegration after 6 weeks and greater than 90% disintegration after 12 weeks according to Disintegration Test Protocol, as described in the specification or in the alternative according to ISO 16929 (2013) or ISO 20200. In one embodiment or in combination with any other embodiment, wherein when the composition is formed into a film having a thickness of 0.38 mm, the film exhibits greater than 50% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a film having a thickness of 0.38 mm, the film exhibits greater than 70% disintegration after 6 weeks and greater than 90% disintegration after 12 weeks according to Disintegration Test Protocol, as described in the specification or in the alternative according to ISO 16929 (2013) or ISO 20200.

In one embodiment or in combination with any other embodiment, when the composition is formed into a film having a thickness of 0.76 mm, the film exhibits greater than 30% disintegration after 12 weeks according to Disintegration Test Protocol, as described in the specification or in the alternative according to ISO 16929 (2013) or ISO 20200. In one embodiment or in combination with any other embodiment, when the composition is formed into a film having a thickness of 0.76 mm, the film exhibits greater than 50% disintegration after 12 weeks according to Disintegration Test Protocol, as described in the specification or in the alternative according to ISO 16929 (2013) or ISO 20200. In one embodiment or in combination with any other embodiment, when the composition is formed into a film having a thickness of 0.76 mm, the film exhibits greater than 70% disintegration after 12 weeks according to Disintegration Test Protocol, as described in the specification or in the alternative according to ISO 16929 (2013) or ISO 20200. In one embodiment or in combination with any other embodiment, when the composition is formed into a film having a thickness of 0.76 mm, the film exhibits greater than 90% disintegration after 12 weeks according to Disintegration Test Protocol, as described in the specification or in the alternative according to ISO 16929 (2013) or ISO 20200. In one embodiment or in combination with any other embodiment, when the composition is formed into a film having a thickness of 0.76 mm, the film exhibits greater than 95% disintegration after 12 weeks according to Disintegration Test protocol, as described in the specification or in the alternative according to ISO 16929 (2013) or ISO 20200.

In another embodiment, a cellulose acetate tow band is provided comprising a cellulose acetate composition; wherein the cellulose acetate composition comprises at least one cellulose ester, at least one plasticizer, at least one alkaline additive, and at least one neutralizing agent; wherein the cellulose acetate composition is biodegradable according to ASTM D6400 when tested under industrial composting conditions.

Typical cigarette filters are made from a continuous-filament tow band of cellulose acetate-based fibers, called cellulose acetate tow, or simply acetate tow. The use of acetate tow to make filters is described in various patents, and the tow may be plasticized. See, for example, U.S. Pat. No. 2,794,239.

Instead of continuous fibers, staple fibers may be used which are shorter, and which may assist in the ultimate degradation of the filters. See, for example, U.S. Pat. No. 3,658,626 which discloses the production of staple fiber smoke filter elements and the like directly from a continuous filamentary tow. These staple fibers also may be plasticized.

Acetate tow for cigarette fibers is typically made up of Y-shaped, small-filament-denier fibers which are intentionally highly crimped and entangled, as described in U.S. Pat. No. 2,953,838. The Y-shape allows optimum cigarette filters with the lowest weight for a given pressure drop compared to other fiber shapes. See U.S. Pat. No. 2,829,027. The small-filament-denier fibers, typically in the range of 1.6-8 denier per filament (dpf), are used to make efficient filters. In constructing a filter, the crimp of the fibers allows improved filter firmness and reduced tow weight for a given pressure drop.

The conversion of acetate tow into cigarette filters may be accomplished by means of a tow conditioning system and a plugmaker, as described, for example, in U.S. Pat. No. 3,017,309. The tow conditioning system withdraws the tow from the bale, spreads and de-registers (“blooms”) the fibers, and delivers the tow to the plugmaker. The plugmaker compresses the tow, wraps it with plugwrap paper, and cuts it into rods of suitable length. To further increase filter firmness, a nonvolatile solvent may be added to solvent-bond the fibers together. These solvent-bonding agents are called plasticizers in the trade, and historically have included triacetin (glycerol triacetate), diethylene glycol diacetate, triethylene glycol diacetate, tripropionin, acetyl triethyl citrate, and triethyl citrate. Waxes have also been used to increase filter firmness. See, for example, U.S. Pat. No. 2,904,050.

Conventional plasticizer fiber-to-fiber bonding agents work well for bonding and selective filtration. However, plasticizers typically are not water-soluble, and the fibers will remain bonded over extended periods of time. In fact, conventional cigarette filters can require years to degrade and disintegrate when discarded, due to the highly entangled nature of the filter fibers, the solvent bonding between the fibers, and the inherent slow degradability of the cellulose acetate polymer. Attempts have therefore been made to develop cigarette filters having improved degradability.

### Examples

### Abbreviations

TFA is trifluoroacetic acid; DMSO-d6 is hexadeuterated dimethylsulfoxide; CA-398-30 is Eastman cellulose acetate CA-398-30; DB is degree of branching;

### Methods:

### Cellulose Diacetate:

CA-398-30 (cellulose diacetate; CDA) was the resin for all examples and measurements. The degree of substitution (DS) is 2.5. Melting point is 230-250° C. and Tg 189° C. The material was compounded into pellets according to the additives mentioned in the examples.

### Rheology

The melt viscosity was measured using parallel plate rheometer-make TA instruments-ARES G2. A frequency sweep was done at 220° C. temperature using circular plates at 1 mm gap.

### Physical Properties

TABLE 1
Physical property and the corresponding standard test method used.

| Test Name | Test Method (ASTM) |
|---|---|
| Tensile Stress at Yield, TS_YIELD, Yield Strength | D638 |
| Tensile Stress at Break, TS_BREAK, Break Strength | |
| Elongation at Break %, EL_BREAK | |
| Tensile Modulus MPa, TENS_MOD | |
| Flexural Modulus Mpa | D790 |
| Flexural Yield Strength (Break Stress) | D790 |
| Izod Impact Strength, Notched (23° C.), Energy, Avg All Modes | D256 |
| Impact Strength, Unnotched (23° C.), Energy, Avg All Modes | D4812 |
| Heat Deflection Temperature (0.455 MPa, 1.82 MPa) | D648 |

### Degree of Branching of Starch Using NMR

Sample preparation: The starch samples were prepared like a typical cellulosic sample. To a tared vial was added about 20 mg sample, a stir bar and 1 mL DMSO-d6. The contents were stirred on a hotplate at 80° C. Once the sample was fully dissolved, it was removed from the hotplate and cooled to room temperature. 80 μL TFA-d/TMS solution was added to the vial, the contents were stirred, and the solution was transferred to a NMR tube. A 1H NMR spectrum was acquired on a 600 MHz Bruker Avance IIIHD spectrometer at 80° C. (64 scans, 15s d1).

The starches shown in Table 2 were obtained from Ingredion.

TABLE 2

| Starch | DB (%) |
|---|---|
| Beneform | 1.2 |
| Douglas | 4.4 |
| ClearFLO | 5.9 |
| ThermFLO | 5.7 |
| Native Corn Starch from Argo | |

### Industrial Compost—Disintegration Performance

The test materials are used as received. The materials were photographed, tagged and placed one test article per sample type in a nylon mesh bag. The bags were filled with compost and placed in the windrows at the start of the active phase. A turned windrow system was utilized during the test. In our trial, the starting feedstock C:N ratio averaged about 24. The average temperature in the windrows over the active phase was about 160° F., and the moisture content varied between 50 & 60%. The active phase lasted 96 days, and the windrows were turned on days 14, 30 and 60. At the end of the active phase, the bags were retrieved from the windrows and dried. The test articles are removed from the bags and photographed.

### Example 1: Disintegration Performance—Commercial Compost

30 mil articles were put in an industrial compost and observed for disintegration at the end of 12 weeks. Sample A with ˜20% PEG-400 plasticizer and no starch did not disintegrate at the end of 12 weeks. Samples B-D with a starch with a DB of 1.2 (Beneform 3750, procured from Ingredion) at 10, 20 and 30% loading, showed beginning of disintegration at 30% loading of starch. However, Sample E-G with starch with DB 4.4 is added at 10, 20 and 30% loading shows significant disintegration (>90%) at 20% loading and complete disintegration (100%) at 30% loading.

TABLE 3
Formulations for Disintegration Study.

| Sample | |
|---|---|
| # | Composition (wt %) |
| A | CA-398-30, PEG400 (19.3) |
| B | CA-398-30, PEG400 (21), Beneform 3750- DB-1.2 (10) |
| C | CA-398-30, PEG400 (21), Beneform 3750- DB-1.2 (20) |
| D | CA-398-30, PEG400 (21), Beneform 3750- DB-1.2 (30) |
| E | CA-398-30, PEG400 (21), Douglas 3060 DB-4.2 (10) |
| F | CA-398-30, PEG400 (21), Douglas 3060 DB-4.2 (20) |
| G | SMASE, PEG400 (21), Douglas 3060 DB 4.2 (30) |

### Example 1.2: Disintegration Performance-Biodegradation Data

### Biodegradation Test in Freshwater Environment

Freshwater biodegradation testing was conducted with the OxiTop OC 110 respirometer for a total of 41 days with the starch samples Beneform 3750, ClearFlo, Douglas 3060, and Argo corn starch. 56 days is the usual length for this test, but an incubator malfunction caused the test to be ended early. The data was then compared to the first 41 days of a previous test from Mar. 25, 2021 that had included the starch ThermFlo. For this test, wastewater was obtained from EMN and used as the sole wastewater source. To account for differences in microbial numbers in the wastewater inoculum for this test, approximately 5% wastewater was added as an inoculum instead of the usual 1%.

TABLE 4

| | Average Final % of |
|---|---|
| Sample | Biodegradation ± Standard Error |
| Cellulose | 70.31 ± 1.94 |
| Beneform 3750 | 28.75 ± 1.65 |
| Argo corn starch | 97.60 ± 1.51 |
| Douglas 3060 | 86.49 ± 2.08 |
| ClearFlo | 83.72 ± 0.92 |
| Cellulose Mar. 25, 2021 | 77.67 ± 7.92 |
| ThermFlo Mar. 25, 2021 | 59.86 ± 0.34 |

Results from this experiment showed the validity of both systems, as the positive control (cellulose) reached greater than 60% biodegradation in both experiments. The results demonstrated that the starch samples, Argo corn starch, Douglas 3060, and ClearFlo, proved to degrade better than the positive control. The starch samples Beneform 3750 degrades the least among the starch additives.

TABLE 5
Formulations, Samples 1-8.

| Sample # | Composition (wt %) |
|---|---|
| 1 | CA-398-30, Beneform 3750 (20) |
| 2 | CA-398-30, Starch ClearFLO (20) |
| 3 | CA-398-30, ThermFLO (20) |
| 4 | CA-398-30, PEG400 (20) |
| 5 | CA-398-30, PEG400 (20), Beneform 3750 DB - |
| | 1.2 (20) |
| 6 | CA-398-30, PEG400 (20), Douglas 3060 (20) |
| 7 | CA-397-30, PEG400 (20), ClearFlo (20) |
| 8 | CA-397-30, PEG400 (20), ThermFlo (20) |

### Example 1.3: Disintegration Performance

30 mil articles were put in an industrial compost (OWS) and observed for disintegration at the end of 12 weeks. The table below shows the representative pictures of the 30 mil thick articles after 12 weeks in the industrial compost. There is a clear difference in the disintegration performance depending on the specific starch additive used. While the 30 mil films with Beneform additive disintegrated the least, the films with Clearflo and Thermflo disintegrated significantly. This data supports the hypothesis that the starch products with higher branching (Clearflo and Thermflo), acts as disintegration rate enhancing additives. Beneform is predominantly a linear starch and hence does not aid in increasing disintegration performance. (cite NMR data for branching). None of the 60 mil plaques disintegrated >50% of their initial weight.

TABLE 6
30 mil articles after 12 weeks in industrial compost (OWS).

| Sample | | Mass (%) remaining |
|---|---|---|
| # | Thickness | after 12 weeks |
| 1 | 30 mil film | >50% remains |
| 2 | 30 mil film | <20% remains |
| 3 | 30 mil film | <20% remains |

### Example 2. Increase in Heat Deflection Temperature

Surprisingly, addition of branched starch additive at 20% loading increased the heat-deflection temperature of the formulation by ˜5-10° C. In contrast, addition of linear starch did not increase the HDT of the formulation.

TABLE 7
HDT measurements for Samples 4-8.

| | HDT |
|---|---|
| Sample # | (0.455 MPa) |
| 4 | 56 |
| 5 | 55.1 |
| 6 | 60.9 |
| 7 | 65.2 |
| 8 | 61.9 |

### Example 3. Rheology Modifier for the CDA Formulation

The melt viscosity of polymer formulations is compared at 100 rad/sec frequency. This frequency is in the range of frequency observed during injection molding. The cellulose ester formulations are known to shear thin at high shear rate. The differences observed in the viscosity are similar over the measured shear rate range (0.6-628 rad/s).

TABLE 8
Viscosity of the different CDA containing formulations.

| | Viscosity at 200° C. and |
|---|---|
| Sample # | 100 rad/sec (Pa · s) |
| 4 | 464.6 |
| 5 | 885.2 |
| 6 | 243.7 |
| 7 | 454.9 |
| 8 | 824.8 |

Formulations with Beneform 3750 and ThermFLO starch have significantly more viscosity than the control formulation without starch. Addition of ClearFLO starch did not change the formulation viscosity significantly. Further, addition of Douglas 3060 decreases the viscosity of the formulation significantly. A lower viscosity is usually desired for reduced back pressure during injection molding. Hence, starch additive can also act as rheology modifier for the CDA formulation.

### Example 4: Visual Appearance of the Starch Formulations

We observe that addition of certain starch grades causes significant dark/brown color in the formulated part (Table below). High acid content of the starch, especially, oxidized starch, is expected to cause color in the CDA formulation by reacting with cellulose acetate.

Color of the 60 mil plaques was measured in CIE L*a*b* color space against a white background using a Konika Minolta Chroma Meter, CR-400, and SpectraMagic NX software. The L* value is a measure of brightness, with L*=0 being black and L*=100 being white.

The values reported in Table 9. are the average of 3 measurements. For comparison, the white and black regions of a Leneta chart are also included.

TABLE 9
Color measurements of the 60 mil plaques

| Plaque | Sample # | L* | a* | b* |
|---|---|---|---|---|
| A | 4 | 60.7 | 5.7 | 34.7 |
| B | 6 | 28.5 | 14.9 | 14.6 |
| D | 7 | 35.1 | 14.6 | 21.2 |
| F | 8 | 69.5 | −0.2 | 21.4 |
| Black | Leneta chart | 21.8 | 0.2 | 0.8 |
| White | | 95.3 | −0.5 | 1.8 |

Without the starch—it is a clear film. When we add the starch—the color changes.

### Example 1.4. Disintegration of Molded Plaques in ISO20200

CA-398-30 was compounded with PEG400 (20 wt %) as a plasticizer, and optionally a starch additive at 20 wt % of the formulation. Plaques were injection molded from the compounded pellets (60 mil thick, 4 inches square).

### ISO20200 Method

Relative disintegration rate of 60 mil injection molded plaques was compared in synthetic compost using a standard lab method (ISO 20200). A synthetic compost mixture is varying percentages of dry mass including ripe compost as an inoculum (Table A). Ripe compost is collected from a composting facility locally and is a fresh sample less than 4 months old. This compost inoculum is sieved through a 5-mil sieve before being mixed into the synthetic formula. The dry ingredients are mixed separately from the wet ingredients them combined and allowed to sit 2-3 hours to soak up the moisture. Once the synthetic compost has absorbed the water content, the mixture is divided between the boxes, with approximately 1000 g per box. At this point the squeeze test is used to see if the material clumps and holds it shape yet does not seep out liquid, this is roughly 55% in moisture content.

TABLE 10
Synthetic compost mixture according to ISO20200

| Material | Dry Mass % |
|---|---|
| Sawdust | 40 |
| Alfalfa | 30 |
| Ripe compost | 10 |
| Corn Starch | 10 |
| Saccharose | 5 |
| Corn Seed Oil | 4 |
| Urea | 1 |
| Deionized water | 1 liter |

The test materials were 60 mil injection molded plaques, cut into 2.5 cm squares with a total starting weight of 7.5 grams. The sample pieces are mixed into the compost, and the total mass of the box, samples, positive control, and samples are recorded.

For the ambient test to simulate home composting conditions, the boxes are put into an incubator or proofing oven at 28° C.±2° C. The samples are then checked at different intervals and maintenance back to 100% of the initial weight for the first 30 days with some mixing and non-mixing. After 30 days the boxes are restored to only 80% of the initial weight then up to 70% after day 60. The testing was terminated at the end of the 180 day incubation period, the material was sieved through a 5 mil, then a 2-mil sieve to separate the remaining films from the synthetic compost material. The remaining pieces were cleaned of surface contamination, and the % disintegration was calculated from the Final dry weight.

TABLE 11
Disintegration of 60 mil Plaque for Samples 4-8.

| Composition - 60 mil | disintegration |
|---|---|
| injection-molded plaques | (wt %) |
| Sample 4 | 32.4 |
| Sample 5 | 26.6 |
| Sample 6 | 32.3 |
| Sample 7 | 35.3 |
| Sample 8 | 32.0 |

### Example 1.5. Disintegration of Molded Cutlery in Outdoor Home Compost Bins

Cellulose diacetate, DS 2.45, Eastman CA394-60S, was compounded with 15% PEG400 as a plasticizer, and optionally a starch additive at 20 wt % of the formulation, according to Table 12. Cutlery was injection molded from the compounded pellets. The molded knives were 16.8 cm in length, 0.9 to 1.8 cm in width and 1.4 to 3.3 mm thick.

TABLE 12
Composition of molded cutlery

| Sample | |
|---|---|
| # | Composition |
| 9 | PEG400 (no starch) (15 wt %) |
| 10 | PEG400 (15 wt %), Douglas 3060 (20 wt %) |
| 11 | PEG400 (15 wt %), 20% ThermFlo (20 wt %) |
| 12 | PEG400 (15 wt %), ARGO native cornstarch (20 wt %) |

For each formulation, 18 knives were weighed and labeled with colored duct tape before placement in outdoor compost bins. The bins were 140 L capacity black plastic household tumblers, initially filled with about 100 L of feedstock (70 L mature compost from a local supplier, 24 L pine shavings, 5 L Alfalfa pellets, 60% moisture). Bins were tumbled weekly and checked for adequate moisture using the squeeze test. Pine shavings were added as needed to keep the compost volume at or above the center axis. Compost was fed ˜1 L of alfalfa pellets at 8, 14 and 20 weeks. After 26 weeks, 9 knives of each formulation were removed from the bins, cleaned, dried, and re-weighed for a final dry weight. The change in average weight and the % weight loss are calculated in Table 13.

TABLE 13
Starting and ending weight and % disintegration

| | | Sample # | | | | | |
|---|---|---|---|---|---|---|---|
| | | | Molded | | | | |
| | | Polystyrene | cornstarch | | | | |
| | | control | control | 9 | 10 | 11 | 12 |
| Starting | Avg | 3.89 | 4.47 | 5.86 | 5.96 | 5.98 | 6.00 |
| wt (g) | n = 18 | | | | | | |
| | st dev | 0.06 | 0.16 | 0.01 | 0.07 | 0.01 | 0.00 |
| Ending | Avg | 3.97 | 3.54 | 4.34 | 3.11 | 2.54 | 2.60 |
| wt (g) | n = 9 | | | | | | |
| | st dev | 0.05 | 0.06 | 0.15 | 0.32 | 0.37 | 0.22 |

| | | | | | | |
|---|---|---|---|---|---|---|
| % wt lost | 0 | 21% | 26% | 48% | 58% | 57% |

1. A cellulose acetate tow band comprising a disintegrable cellulose acetate composition; wherein said disintegrable cellulose ester composition comprising at least one biodegradable cellulose ester and at least one biodegradable, branched starch; wherein said branched starch has a degree of branching of 2 to 6; wherein said cellulose ester composition has a disintegrable rate of 50% or more

2. The cellulose acetate tow band according to claim 1 wherein said cellulose acetate has a DS/AGU of about 1 to about 2.5.

3. The cellulose acetate tow band according to claim 1 wherein said cellulose acetate is cellulose diacetate having a polystyrene equivalent number average molecular weights (Mn) from 10,000 to 90,000.

4. The cellulose acetate tow band according to claim 1 wherein said cellulose acetate is prepared by converting cellulose to a cellulose acetate with reactants that are obtained from recycled materials.

5. The cellulose acetate tow band according to claim 1 wherein said plasticizer is at least one selected from the group consisting of glycerol triacetate (Triacetin), glycerol diacetate, dibutyl terephthalate, dimethyl phthalate, diethyl phthalate, poly(ethylene glycol) MW 200-600, triethylene glycol dipropionate, 1,2-epoxypropylphenyl ethylene glycol, 1,2-epoxypropyl(m-cresyl) ethylene glycol, 1,2-epoxypropyl(o-cresyl) ethylene glycol, β-oxyethyl cyclohexenecarboxylate, bis(cyclohexanate) diethylene glycol, triethyl citrate, polyethylene glycol, Benzoflex, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate, triethyl citrate, acetyl triethyl citrate, polyethylene glycol, the benzoate containing plasticizers such as the Benzoflex™ plasticizer series, poly (alkyl succinates) such as poly (butyl succinate), polyethersulfones, adipate based plasticizers, soybean oil epoxides such as the Paraplex™ plasticizer series, sucrose based plasticizers, dibutyl sebacate, tributyrin, tripropionin, sucrose acetate isobutyrate, the Resolflex™ series of plasticizers, triphenyl phosphate, glycolates, methoxy polyethylene glycol, 2,2,4-trimethylpentane-1,3-diyl bis(2-methylpropanoate), and polycaprolactones.

6. The cellulose acetate tow band according to claim 1 wherein said plasticizer is present in an amount from 1 to 40 wt %.

7. The cellulose acetate tow band according to claim 1 wherein said plasticizer is selected from the group consisting of PEG and MPEG (methoxy PEG).

8. The cellulose acetate tow band according to claim 1 wherein said cellulose ester composition comprises a biodegradable cellulose ester (BCE) component and at least one other biodegradable polymer other than the BCE.

9. The cellulose acetate tow band according to claim 1 wherein said branched starch has a degree of branching of 3 or greater

10. The cellulose ester tow band of claim 9 wherein said branched starch is at least one selected from the group consisting of tulip starch, waxy corn starch, waxy potato starch, native corn starch, and potato starch.

11. The cellulose ester tow band of claim 9 wherein said branched starch in said cellulose ester composition ranges from about 1 to about 50% by weight based on the cellulose ester composition.

12. The cellulose ester tow band of claim 9 wherein said branched starch in said cellulose ester composition ranges from about 5 to about 50% by weight based on the cellulose ester composition.
